(19) United States
(12) Patent Application Publication
(10) Pub. No.: US 2026/0160210 A1
(43) Pub. Date: Jun. 11, 2026

(54) THROTTLE MECHANISM

(71) Applicant: HONDA MOTOR CO., LTD., Tokyo (JP)

(72) Inventor: Tetsuya Arai, Tokyo (JP)

(21) Appl. No.: 19/395,422

(22) Filed: Nov. 20, 2025

(30) Foreign Application Priority Data
Dec. 5, 2024 (JP) 2024-212419

(51) Int. Cl. F02D 9/10

(52) U.S. Cl. CPC F02D 9/1035

(57) ABSTRACT

Provided is a throttle mechanism including a throttle body in which a throttle valve is disposed, the throttle body including: a rotation portion that rotates the throttle valve; a cover that covers the rotation portion; and an adjustment portion that adjusts a position of the rotation portion, wherein a part of the adjustment portion is located outside the throttle body, and the cover includes a guard portion that covers a part of the adjustment portion.

### INCORPORATION BY REFERENCE

The present application claims priority under 35 U.S.C. § 119 to Japanese Patent Application No. 2024-212419 filed on Dec. 5, 2024. The content of the application is incorporated herein by reference in its entirety.

### BACKGROUND

### Technical Field

The present invention relates to a throttle mechanism.

### Related Art

A throttle mechanism including an adjustment portion that adjusts a position of a throttle valve is known (See, for example, Japanese Patent Laid-Open No. 9-053468). In Japanese Patent Laid-Open No. 9-053468, a bolt functioning as an adjustment screw for regulating maximum rotation of an engine is provided as the adjustment portion, and readjustment is regulated by covering a head of this bolt with a cap. The cap is fixed by being driven, and the cap is configured not to be detached unless it is broken by hitting with a sharp rod or the like. As another form, a method of filling the adjustment screw with resin is also known.

However, in the case of covering with the cap, work of driving the cap is required, which takes time and effort. In addition, since the cap is exposed to the outside, the presence of the cap is easily recognized from the outside. In the case where the adjustment screw is filled with resin, a step of filling with resin, a drying step, and the like are required, and thus this case also takes time and effort.

The present invention has been made in view of the above circumstances, and an object thereof is to make, with a simple configuration, it difficult to readjust a throttle valve.

### SUMMARY

In a throttle mechanism including a throttle body in which a throttle valve is disposed, the throttle body includes: a rotation portion that rotates the throttle valve; a cover that covers the rotation portion; and an adjustment portion that adjusts a position of the rotation portion. Further, a part of the adjustment portion is located outside the throttle body, and the cover includes a guard portion that covers a part of the adjustment portion.

According to the present invention, since the cover and the guard portion are integrally molded, there is a sense of unity, and since a part of the adjustment portion is covered by the guard portion provided in the cover, it is difficult for an unintended person to estimate the position of the adjustment portion. Therefore, it is possible to restrain an unintended person from operating and adjusting the adjustment portion.

### BRIEF DESCRIPTION OF DRAWINGS

FIG. 1 is a front view of an internal combustion engine;

FIG. 2 is a perspective view of the throttle mechanism;

FIG. 3 is a perspective view in which a cover is removed from the throttle mechanism;

FIG. 4 is a view illustrating the throttle mechanism from a side surface;

FIG. 5 is a view illustrating the throttle mechanism from a front surface;

FIG. 6 is an enlarged view of a region A in FIG. 5; and

FIG. 7 is a view illustrating a throttle mechanism according to a second embodiment from a front surface.

### DETAILED DESCRIPTION

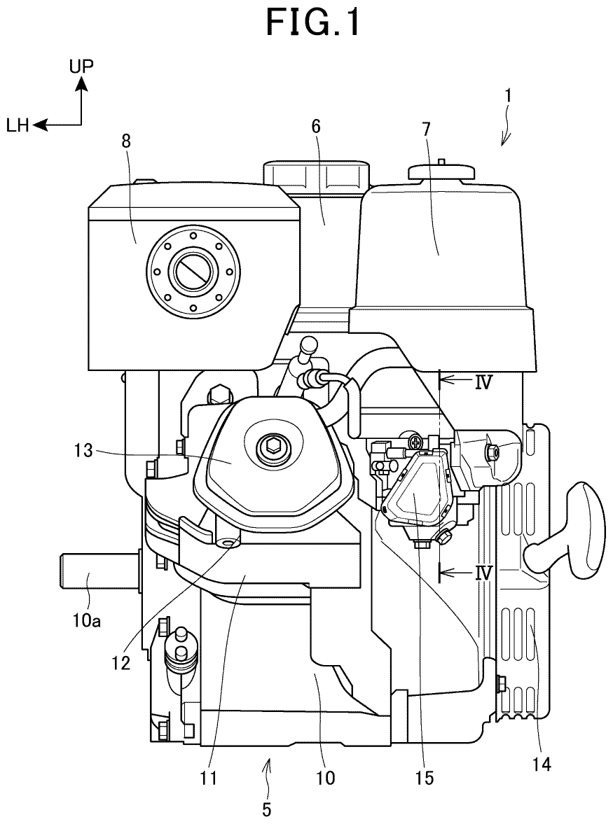

Hereinafter, embodiments of the present invention will be described with reference to the drawings. Note that, in the description, directions such as front, rear, left, right, up, and down are the same as directions with respect to an internal combustion engine of FIG. 1 unless otherwise specified. In addition, reference sign FR in each of the drawings indicates a front side of the internal combustion engine, reference sign UP indicates an internal combustion engine side, and reference sign LH indicates a left side of the internal combustion engine.

### First Embodiment

FIG. 1 is a front view of an internal combustion engine 1.

The internal combustion engine 1 is a general-purpose engine used as a power source of various machines. The internal combustion engine 1 of the present embodiment is an air-cooled single-cylinder engine.

The internal combustion engine 1 includes an internal combustion engine body 5, a fuel tank 6 attached to a rear upper portion of the internal combustion engine body 5, an air cleaner box 7 disposed on an upper right side of the internal combustion engine 1, and a silencer 8 disposed on an upper left side of the internal combustion engine 1.

The internal combustion engine body 5 includes a crankcase 10, a cylinder block 11, a cylinder head 12, and a head cover 13. A fan cover 14 is disposed on a right side of the internal combustion engine body 5.

In the crankcase 10, a crankshaft 10a is rotatably supported. The crankshaft 10a extends in a left-right direction, and is partially exposed from the left side of the internal combustion engine 1. A machine using the internal combustion engine 1 as a power source is connected to an exposed portion of the crankshaft 10a.

The cylinder block 11 has a cylinder chamber in which a piston is slidably disposed, and a combustion chamber is formed between the piston and the cylinder head 12. The piston is connected to the crankshaft 10a via a connecting rod, and the crankshaft 10a rotates in accordance with sliding of the piston.

The cylinder head 12 has an intake port and an exhaust port communicating with the combustion chamber. A valve mechanism that opens and closes each of the ports is disposed between the cylinder head 12 and the head cover 13. The intake port opens on a right side surface of the cylinder head 12, and the throttle mechanism 15 is connected to the right side surface of the cylinder head 12 so as to be connected to the intake port. In addition, the air cleaner box 7 is connected to an opposite side of the throttle mechanism 15.

The throttle mechanism 15 supplies the air cleaned by the air cleaner box 7 to the internal combustion engine body 5 and variably controls an air supply amount. Further, an injector 21 is connected to the throttle mechanism 15, and a fuel in the fuel tank 6 is supplied to the internal combustion engine body 5 by the injector 21. That is, the throttle mechanism 15 and the air cleaner box 7 constitute an intake system of the internal combustion engine 1.

The exhaust port opens on a left side surface of the cylinder head 12, and the silencer 8 is connected via an exhaust pipe. As a result, an exhaust gas discharged from the exhaust port is discharged to outside via the exhaust pipe and the silencer 8. That is, the exhaust pipe and the silencer 8 constitute an exhaust system of the internal combustion engine 1.

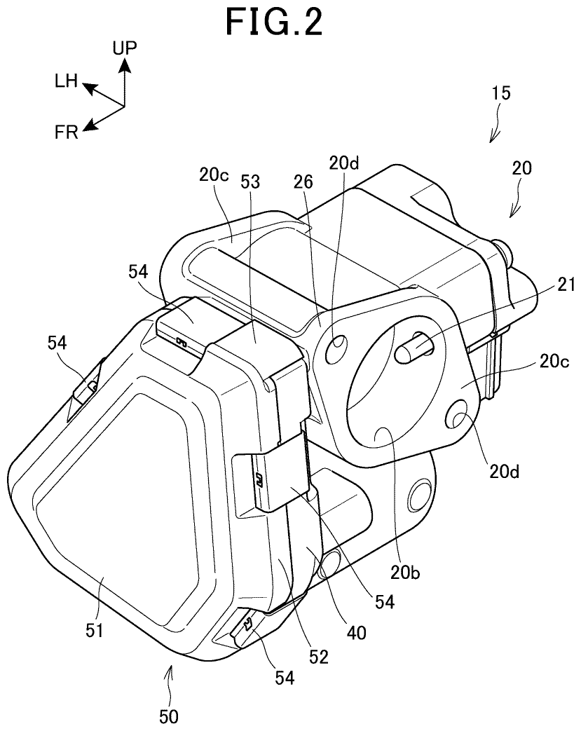

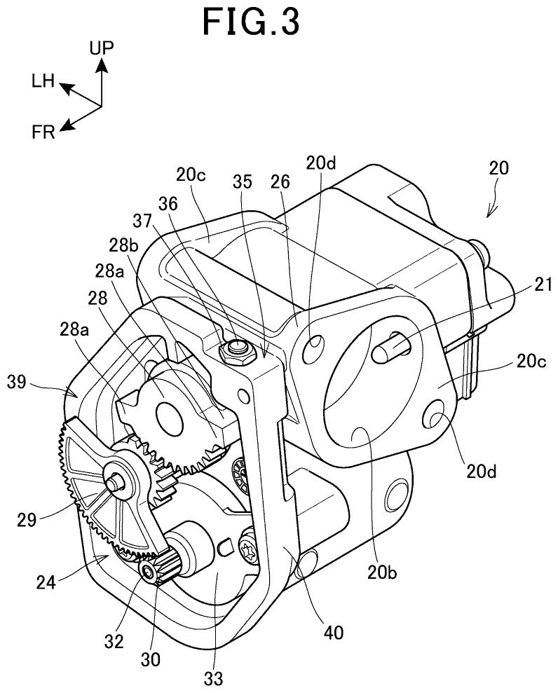

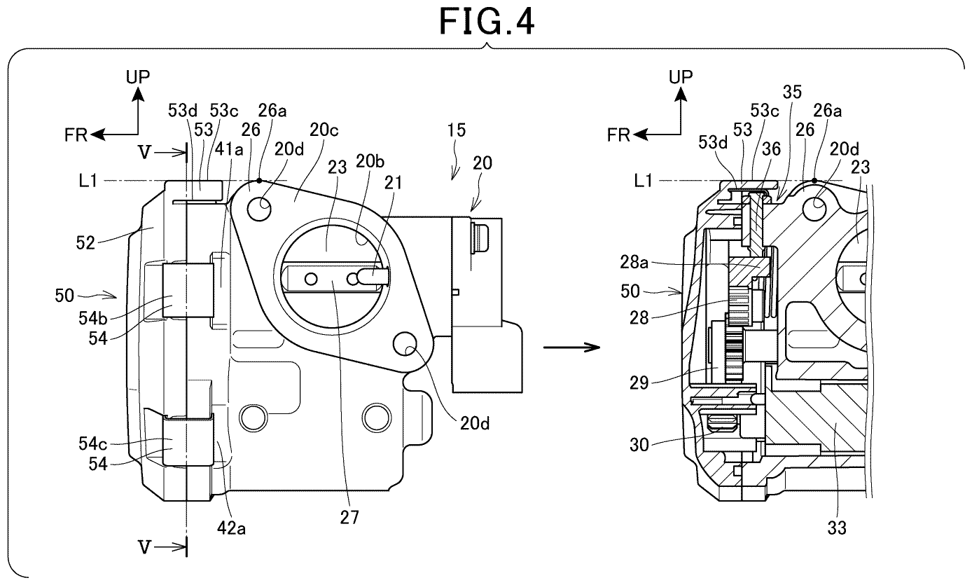

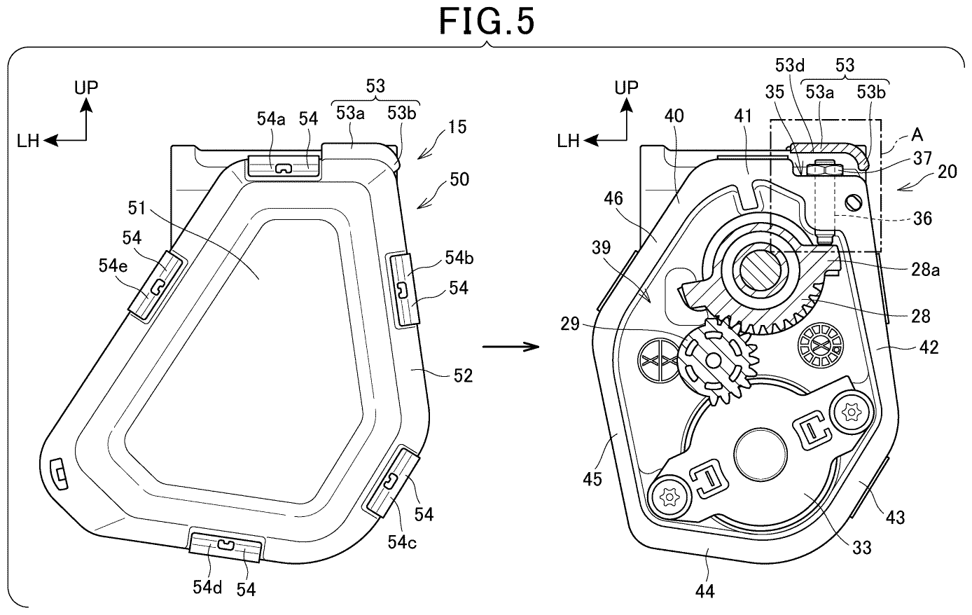

FIG. 2 is a perspective view of the throttle mechanism 15. FIG. 3 is a perspective view in which a cover 50 is removed from the throttle mechanism 15. A side view of the throttle mechanism 15 is illustrated on a left side of FIG. 4, and a side cross-sectional view of the throttle mechanism 15 taken along line IV-IV of FIG. 1 is illustrated on a right side. A front view of the throttle mechanism 15 is illustrated on a left side of FIG. 5, and a cross-sectional view of the throttle mechanism 15 taken along line V-V of FIG. 4 is illustrated on a right side.

As illustrated in FIGS. 2, 3, the throttle mechanism 15 includes a throttle body 20 including a throttle valve 23, a rotation portion 24 that rotates the throttle valve 23, and the cover 50 that covers the rotation portion 24 and a recessed portion 35.

The throttle body 20 includes the throttle valve 23 that controls an amount of air passing through a port 20b and an adjustment mechanism that adjusts an opening degree of the throttle valve 23. The port 20b is a hole having a substantially circular cross section penetrating the throttle body 20 in the left-right direction. Flange portions 20c are provided at left and right ends of the port 20b. Each of the flange portions 20c is formed in a substantially rhombic flange protruding toward an upper front end side and a lower rear side, and flange holes 20d penetrating in the left-right direction are formed on the upper front end side and the lower rear side.

The left flange portion 20c functions as a connection portion connected to the cylinder head 12, and the right flange portion 20c functions as a connection portion connected to the air cleaner box 7.

That is, the throttle body 20 is disposed between the cylinder head 12 and the air cleaner box 7, and bolts (not illustrated) are passed through the flange holes 20d from an air cleaner box 7 side, and the bolts are fastened to the cylinder head 12, whereby the left flange portion 20c is connected to the cylinder head 12, and the right flange portion 20c is connected to the air cleaner box 7. The port 20b constitutes an intake passage between the air cleaner box 7 and the intake port of the cylinder head 12.

A cylindrical portion for forming the flange holes 20d is integrally provided between upper front ends of the left and right flange portions 20c. This cylindrical portion and upper portions of the left and right flange portions 20c form a protruding portion 26 protruding upward at an upper portion of the throttle body 20.

A configuration related to the adjustment mechanism that adjusts the opening degree of the throttle valve 23 will be described.

As illustrated in FIG. 4, the port 20b is provided with the throttle valve 23 that opens and closes the port 20b. The throttle valve 23 is fixed to a throttle shaft 27. At a front end of the throttle shaft 27, a valve gear 28, which is described later, is fixed.

As illustrated in FIGS. 3 and 5, the throttle body 20 has an edge portion 40 protruding in a cylindrical shape toward the front end side, and an opening portion 39 that is a space in which the front surface side is opened is formed at a front end of the throttle body 20 by the edge portion 40.

As illustrated in FIG. 5, the edge portion 40 is formed in a rib shape extending endlessly along a substantially polygonal outer shape, and thus has a first surface 41 extending in the left-right direction on an upper side of the throttle body 20 in front view, a second surface 42 extending rightward and downward from a right end portion of the first surface 41, a third surface 43 extending leftward and downward from a lower end portion of the second surface 42, a fourth surface 44 extending leftward and upward from a lower end portion of the third surface 43, a fifth surface 45 extending further leftward and upward from a left end portion of the fourth surface 44, and a sixth surface 46 connecting a left end portion of the fifth surface 45 and a left end portion of the first surface 41.

The recessed portion 35 recessed downward is formed at the right end portion of the first surface 41. The recessed portion 35 is provided adjacent to the protruding portion 26 in a front-rear direction. The recessed portion 35 has a female screw hole penetrating the edge portion 40 in an up-down direction. An adjustment portion 36 formed of a shaft member forming a male screw is fastened to the female screw hole.

As illustrated in FIG. 3, the rotation portion 24 for rotating the throttle valve 23 is accommodated in the opening portion 39. The rotation portion 24 includes the valve gear 28 fixed to the throttle valve 23, an intermediate gear 29 meshing with the valve gear 28, and a motor gear 30 meshing with the intermediate gear 29.

The valve gear 28 is a gear having the throttle shaft 27 as a rotation axis. The valve gear 28 has protrusion portions 28a protruding radially outward.

When the valve gear 28 rotates the throttle valve 23 to a close side, a tip of the adjustment portion 36 abuts on a flat surface 28b of one of the protrusion portions 28a, so that further rotation of the throttle valve 23 to the close side is restricted. As a result, a closed position of the throttle valve 23 is set by adjusting a position of the adjustment portion 36.

The adjustment portion 36 is one example of an “adjustment portion that adjusts a closing degree position of the throttle valve” of the present disclosure, and a configuration and a shape of the adjustment portion 36 may be appropriately changed.

The intermediate gear 29 includes a gear that meshes with the valve gear 28 and a gear that meshes with the motor gear 30. The motor gear 30 is a gear fixed to a motor shaft 32 of a throttle motor 33. Rotation of the throttle motor 33 is transmitted to the valve gear 28 via the motor gear 30 and the intermediate gear 29, whereby the throttle valve 23 is rotated to an open side and the close side.

By rotating the throttle valve 23 to the open side and the close side, an amount of air taken into the combustion chamber is adjusted.

It is preferable that the adjustment portion 36 cannot be easily changed by an unintended person.

In the present embodiment, a position on the close side of the throttle valve 23 is adjusted using the adjustment portion 36 at the time of manufacturing or immediately after manufacturing the internal combustion engine 1. After the adjustment, an adjusting nut 37 is fastened to an upper portion of the adjustment portion 36. Furthermore, the position of the adjustment portion 36 is fixed by restricting rotation of the adjusting nut 37 by adhesion.

Furthermore, in the present embodiment, a head portion of the adjustment portion 36 is cut after the position on the close side of the throttle valve 23 is adjusted, so that an amount of upward protrusion of the adjustment portion 36 is reduced and it is difficult for an unintended person to adjust the adjustment portion 36. Note that a method of fixing the adjustment portion 36 after the adjustment may be appropriately changed, or the head portion of the adjustment portion 36 may not be cut.

Note that the adjustment portion 36 does not affect the opening degree of the throttle valve 23 during operation.

The opening portion 39 is provided with the cover 50 that seals the opening portion 39 by abutting on the edge portion 40. As illustrated in FIGS. 2 and 4, claw receiving portions 40a that are recesses for fitting with claw portions 54 of the cover 50 to be described later are formed at an outer end of the edge portion 40. The claw receiving portions 40a are provided with respect to the first surface 41, the second surface 42, the third surface 43, the fourth surface 44, and the sixth surface 46.

The cover 50 includes a cover wall portion 52 that abuts on front ends of the first surface 41, the second surface 42, the third surface 43, and the fourth surface 44, and a front end of the sixth surface 46 of the edge portion in front view, a cover body portion 51 that covers the opening portion 39 and a front end of the edge portion 40, and a guard portion 53 that covers the adjustment portion 36 exposed to the outside from the recessed portion 35. That is, the guard portion 53 extends from an end portion of the cover body portion 51 to a throttle body 20 side (rear side) so as to be close to the protruding portion 26 of the throttle body 20, and covers an upper surface and a right side surface of the recessed portion 35. In this manner, by disposing a rear end of the guard portion 53 and the protruding portion 26 so as to be close to each other, the adjustment portion 36 is hardly seen from a gap between the guard portion 53 and the throttle body 20, and the position of the adjustment portion 36 is hardly determined from appearance.

Note that the rear end of the guard portion 53 and the protruding portion 26 may be in contact with each other when the rear end of the guard portion 53 and the protruding portion 26 are close to each other. By providing the guard portion 53 and the protruding portion 26 so that the rear end of the guard portion 53 and the protruding portion 26 are in contact with each other, the position of the adjustment portion 36 can be more hardly determined from the appearance.

In addition, as illustrated in FIG. 4, an upper end 53c of the guard portion 53 and an upper end 26a of the protruding portion 26 have a same height. Therefore, in side view of the throttle mechanism 15, the upper end 53c of the guard portion 53 is located on a tangent L1 to the upper end 26a of the protruding portion 26.

In the present embodiment, the upper end 53c of the guard portion 53 is an upper surface of a first guard portion 53a, and the upper surface of the first guard portion 53a and the upper end 26a of the protruding portion 26 have the same height. In addition, the upper end 26a of the protruding portion 26 is higher than a lower surface 53d of the guard portion 53. As a result, it is possible to suppress local bulging of the throttle body 20 due to the provision of the adjustment portion 36, and thus, it is possible to make it difficult to estimate the position of the adjustment portion 36 from the appearance.

Further, the adjustment portion 36 is disposed in the recessed portion 35 provided in the edge portion 40. In other words, since the adjustment portion 36 is provided in the recessed portion 35 provided at a position lower than the upper end 26a of the protruding portion 26, it is possible to secure a space of the adjustment portion 36 while suppressing the local bulging of the throttle body 20. Therefore, the throttle mechanism 15 can be made compact.

The cover wall portion 52 is provided with the plurality of claw portions 54 extending rearward. The claw portions 54 are provided at positions corresponding to the claw receiving portions 40a provided in the edge portion 40, and the cover 50 is fixed to the throttle body 20 by the claw portions 54 being fitted with the claw receiving portions 40a.

In the present embodiment, a total of five claw portions 54 are provided, that is, an upper claw portion 54a fitted with a claw receiving portion 41a of the first surface 41, a right upper claw portion 54b fitted with a claw receiving portion 42a of the second surface 42, a right lower claw portion 54c fitted with a claw receiving portion 43a of the third surface 43, a lower claw portion 54d fitted with a claw receiving portion 44a of the fourth surface 44, and a left claw portion 54e fitted with a claw receiving portion 46a of the sixth surface 46.

In the present embodiment, the upper claw portion 54a is formed on the left of recessed portion 35 in front view.

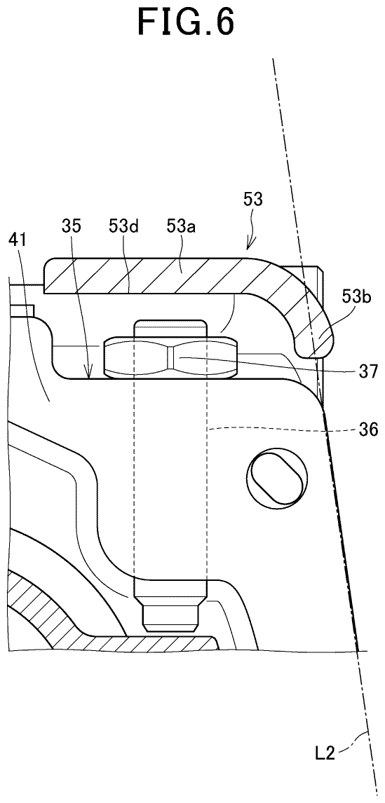

FIG. 6 is an enlarged view of a region A in FIG. 5.

The guard portion 53 covers an upper portion and a right side portion of the recessed portion 35. The guard portion 53 includes the first guard portion 53a that covers the upper portion of the recessed portion 35, and a second guard portion 53b that is curved from a right end of the first guard portion 53a and extends to cover a right end of the recessed portion 35, the adjustment portion 36, and the adjusting nut 37 from a right side.

The second guard portion 53b extends along a tangent to a surface of the throttle body 20 located in an extending direction of the second guard portion 53b. In the present embodiment, the second guard portion 53b extends along a tangent L2 to the second surface 42 of the throttle body 20 located in the extending direction of the second guard portion 53b in front view. As a result, it is possible to suppress occurrence of a step among the second guard portion 53b, the second surface 42 of the edge portion 40, and a surface of the cover wall portion 52 that abuts on the second guard portion 53b and the second surface 42 of the edge portion 40. Therefore, it is possible to suppress rightward bulging of the throttle body 20 due to the provision of the adjustment portion 36, and thus, it is possible to make it difficult to estimate the position of the adjustment portion 36 from the appearance.

As a result, the upper end of the recessed portion 35 is covered with the first guard portion 53a, and the right end is covered with the second guard portion 53b. A left end of the recessed portion 35 is covered with the upper claw portion 54a. The rear end is covered with the protruding portion 26, and a front end is covered with the cover 50. That is, a periphery of the recessed portion 35 is covered with the other members. Therefore, the presence of the adjustment portion 36 is hidden from the appearance, and it is difficult for an unintended person to estimate the position of the adjustment portion. Therefore, it is possible to make it difficult for an unintended person to readjust the adjustment portion 36.

As described above, in the throttle mechanism 15 including the throttle body 20 in which the throttle valve 23 is disposed, the throttle body 20 includes the rotation portion 24 that rotates the throttle valve 23, the cover 50 that covers the rotation portion 24, and the adjustment portion 36 that adjusts the position of the rotation portion 24, a part of the adjustment portion 36 is located outside the throttle body 20, and the cover 50 includes the guard portion 53 that covers a part of the adjustment portion 36.

According to this, since the cover 50 and the guard portion 53 are integrally molded, there is a sense of unity, and since a part of the adjustment portion 36 is covered by the guard portion 53 included in the cover 50, it is difficult for an unintended person to estimate the position of the adjustment portion 36. Therefore, it is possible to restrain an unintended person from operating and adjusting the adjustment portion 36.

The guard portion 53 extends to the side away from the cover 50, and the end portion of the guard portion 53 on the side away from the cover 50 is in contact with or close to the throttle body 20.

According to this, by providing the guard portion 53 so as to be close to or in contact with the throttle body 20, it is possible to cover and hide at least a part of the adjustment portion 36 of the throttle body 20 exposed to the outside. Therefore, it is difficult for an unintended person to estimate the position of the adjustment portion 36, and it is possible to restrain the unintended person from readjusting the adjustment portion 36.

The throttle body 20 includes the recessed portion 35, and a part of the adjustment portion 36 is accommodated in the space formed by the recessed portion 35.

According to this, the protrusion of the adjustment portion 36 is suppressed by the recessed portion 35, and the local bulging of the guard portion 53 from the throttle body 20 can be suppressed.

The throttle body 20 includes the protruding portion 26 adjacent to the recessed portion 35, the protruding portion 26 is disposed on the opposite side of the cover 50 with the recessed portion 35 interposed, the recessed portion 35 is recessed downward, and the upper end 26a of the protruding portion 26 is higher than the lower surface 53d of the guard portion 53.

According to this, at least a part of the adjustment portion 36 provided in the recessed portion 35 can be hidden by the protruding portion 26. Therefore, it is difficult for an unintended person to recognize the presence of the adjustment portion 36 from the rear, and it is difficult to estimate the position of the adjustment portion 36.

The guard portion 53 includes the first guard portion 53a that covers the upper surface of the adjustment portion 36, and the second guard portion 53b that extends from the one end of the first guard portion 53a so as to cover a part of the side of the adjustment portion 36.

According to this, the second guard portion 53b makes it difficult for an unintended person to visually recognize the adjustment portion 36 from the side surface. Therefore, it is difficult for an unintended person to recognize the presence of the adjustment portion 36, and it is possible to restrain the unintended person from operating and adjusting the adjustment portion 36.

In the cover 50, the plurality of claw portions 54 engaged with the throttle body 20 are disposed at intervals, and any of the claw portions 54 is disposed at a position adjacent to the other end side of the first guard portion 53a.

According to this, the adjustment portion 36 can be hidden by the claw portion 54, and it becomes difficult for an unintended person to visually recognize the adjustment portion 36 from the side surface. In addition, since the cover 50 cannot be opened unless all the claw portions 54 are broken, it is possible to restrain an unintended person from easily operating the adjustment portion 36.

The second guard portion 53b extends along the tangent to the surface of the throttle body 20 located in the extending direction of the second guard portion 53b.

According to this, it is possible to suppress the local bulging of the throttle body 20 due to the provision of the adjustment portion 36, and thus, it is possible to make it difficult to estimate the position of the adjustment portion 36 from the appearance.

The upper end 26a of the protruding portion 26 and the upper end 53c of the guard portion 53 have the same height.

According to this, it is possible to suppress the local bulging of the throttle body 20 due to the provision of the adjustment portion 36, and thus, it is possible to make it difficult to estimate the position of the adjustment portion 36 from the appearance.

### Second Embodiment

A second embodiment to which the present invention is applied will be described. In the second embodiment, parts configured in the same manner as in the first embodiment are denoted by the same reference signs and will not be described.

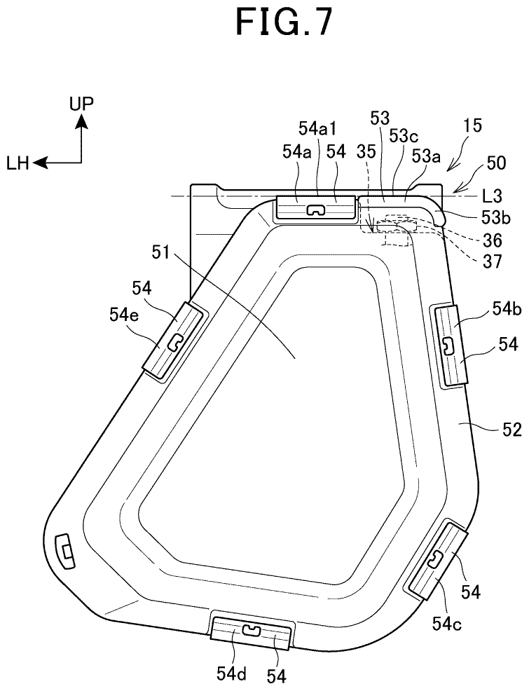

FIG. 7 is a view illustrating a throttle mechanism 15 according to the second embodiment from the front.

In the first embodiment described above, the upper end 53c of the guard portion 53 and the upper end 26a of the protruding portion 26 have the same height.

In the second embodiment, the upper end 53c of the guard portion 53 and the upper end of the claw portion 54 adjacent to the other end side of the first guard portion 53a have a same height. More particularly, an upper end 54a1 of the upper claw portion 54a adjacent to the first guard portion 53a, and the upper end 53c of the first guard portion 53a have the same height. Therefore, in front view of the throttle mechanism 15, the upper end 53c of the first guard portion 53a is located on a tangent L3 to the upper end 54a1 of the upper claw portion 54a.

In the present exemplary embodiment, the upper end 54a1 of the upper claw portion 54a is an upper surface of the upper claw portion 54a, and the upper end 53c of the first guard portion 53a is the upper surface of the first guard portion 53a. Therefore, the upper surface of the upper claw portion 54a and the upper surface of the first guard portion 53a have the same height.

As a result, it is possible to suppress the local bulging of the throttle body 20 due to the provision of the adjustment portion 36, and thus, it is possible to make it difficult to estimate the position of the adjustment portion 36 from the appearance.

As described above, according to the second embodiment to which the present invention is applied, since the upper end 54a1 of the claw portion 54 adjacent to the other end side of the first guard portion 53a and the upper end 53c of the guard portion 53 have the same height, the bulging of the throttle body 20 due to the provision of the adjustment portion 36 is suppressed. Therefore, it is difficult for a person who does not intend to adjust the adjustment portion 36 to determine that the adjustment portion 36 exists under the guard portion 53. That is, it becomes difficult to estimate the position of the adjustment portion 36.

### Other Embodiments

Each of the embodiments described above merely illustrates one aspect of the present invention, and can be arbitrarily modified and applied within a range not departing from the spirit of the present invention.

In the above-described embodiment, the configuration and the disposition of the internal combustion engine 1 may be appropriately changed, and for example, a cooling system of the engine and a number of cylinders can be appropriately changed.

In the first embodiment described above, an example has been described in which the upper end 26a of the protruding portion 26 and the upper end 53c of the guard portion 53 have the same height. In addition, in the second embodiment described above, an example has been described in which the upper end 54a1 of the upper claw portion 54a of the first guard portion 53a and the upper end 53c of the guard portion 53 have the same height. All of these may have the same height. That is, the upper end of the protruding portion, the upper end of the guard portion, and the upper end of the claw portion adjacent to the first guard portion may have the same height.

### Configurations Supported by Above Embodiments

The above embodiments support configurations below.

(Configuration 1) A throttle mechanism including a throttle body in which a throttle valve is disposed, the throttle body including: a rotation portion that rotates the throttle valve; a cover that covers the rotation portion; and an adjustment portion that adjusts a position of the rotation portion, wherein a part of the adjustment portion is located outside the throttle body; and the cover includes a guard portion that covers a part of the adjustment portion.

According to this, since the cover and the guard portion are integrally molded, there is a sense of unity, and since a part of the adjustment portion is covered by the guard portion included in the cover, it is difficult for an unintended person to estimate the position of the adjustment portion. Therefore, it is possible to restrain an unintended person from operating and adjusting the adjustment portion.

(Configuration 2) The throttle mechanism according to Configuration 1, wherein the guard portion extends to a side away from the cover, and an end portion of the guard portion on the side away from the cover is in contact with or close to the throttle body.

According to this, by providing the guard portion so as to be close to or in contact with the throttle body, it is possible to cover and hide at least a part of the adjustment portion of the throttle body, the part being exposed to the outside. Therefore, it is difficult for an unintended person to estimate the position of the adjustment portion, and it is possible to restrain an unintended person from readjusting the adjustment portion.

(Configuration 3) The throttle mechanism according to Configuration 1 or 2, wherein the throttle body includes a recessed portion, and a part of the adjustment portion is accommodated in a space formed by the recessed portion.

According to this, the protrusion of the adjustment portion is suppressed by the recessed portion, and it is possible to suppress local bulging of the guard portion from the throttle body.

(Configuration 4) The throttle mechanism according to Configuration 3, wherein the throttle body includes a protruding portion adjacent to the recessed portion, the protruding portion is disposed on an opposite side of the cover with the recessed portion interposed therebetween, and the recessed portion is recessed downward, and an upper end of the protruding portion is higher than a lower surface of the guard portion.

According to this, at least a part of the adjustment portion provided in the recessed portion can be hidden by the protruding portion. Therefore, it is difficult for an unintended person to recognize the presence of the adjustment portion from the rear, and it is difficult to estimate the position of the adjustment portion.

(Configuration 5) The throttle mechanism according to Configurations 2 to 4, wherein the guard portion includes a first guard portion that covers an upper surface of the adjustment portion, and a second guard portion that extends from one end of the first guard portion so as to cover a part of a side of the adjustment portion.

According to this, the second guard portion makes it difficult for an unintended person to visually recognize the adjustment portion from a side surface. Therefore, it is difficult for an unintended person to recognize the presence of the adjustment portion, and it is possible to restrain the unintended person from operating and adjusting the adjustment portion.

(Configuration 6) The throttle mechanism according to Configuration 5, wherein in the cover, a plurality of claw portions engaged with the throttle body are disposed at intervals, and any of the claw portions is disposed at a position adjacent to another end side of the first guard portion.

According to this, the adjustment portion can be hidden by the claw portion, and it becomes difficult for an unintended person to visually recognize the adjustment portion from the side surface. In addition, since the cover cannot be opened unless all the claw portions are broken, it is possible to restrain an unintended person from easily operating the adjustment portion.

(Configuration 7) The throttle mechanism according to Configuration 5 or 6, wherein the second guard portion extends along a tangent to a surface of the throttle body located in an extending direction of the second guard portion.

According to this, it is possible to suppress local bulging of the throttle body due to the provision of the adjustment portion, and thus, it is possible to make it difficult to estimate the position of the adjustment portion from the appearance.

(Configuration 8) The throttle mechanism according to Configurations 5 to 7, wherein an upper end of the claw portion adjacent to the other end side of the first guard portion and an upper end of the guard portion have a same height.

According to this, it is possible to suppress bulging of the throttle body due to the provision of the adjustment portion, and thus, it is possible to make it difficult to estimate the position of the adjustment portion from the appearance.

(Configuration 9) The throttle mechanism according to Configurations 4 to 8, wherein the upper end of the protruding portion and the upper end of the guard portion have a same height.

According to this, it is possible to suppress the bulging of the throttle body due to the provision of the adjustment portion, and thus, it is possible to make it difficult to estimate the position of the adjustment portion from the appearance.

### Reference Signs List

15 throttle mechanism
20 throttle body
23 throttle valve
24 rotation portion
26 protruding portion
35 recessed portion
36 adjustment portion
50 cover
53 guard portion
53a first guard portion
53b second guard portion
54 claw portion

What is claimed is:

1. A throttle mechanism including a throttle body in which a throttle valve is disposed, the throttle body comprising:
a rotation portion that rotates the throttle valve;
a cover that covers the rotation portion; and
an adjustment portion that adjusts a position of the rotation portion,
wherein a part of the adjustment portion is located outside the throttle body, and
the cover includes a guard portion that covers a part of the adjustment portion.

2. The throttle mechanism according to claim 1, wherein
the guard portion extends to a side away from the cover, and
an end portion of the guard portion on the side away from the cover is in contact with or close to the throttle body.

3. The throttle mechanism according to claim 1, wherein
the throttle body includes a recessed portion, and
a part of the adjustment portion is accommodated in a space formed by the recessed portion.

4. The throttle mechanism according to claim 3, wherein
the throttle body includes a protruding portion adjacent to the recessed portion,
the protruding portion is disposed on an opposite side of the cover with the recessed portion interposed therebetween, and
the recessed portion is recessed downward, and an upper end of the protruding portion is higher than a lower surface of the guard portion.

5. The throttle mechanism according to claim 4, wherein the guard portion includes a first guard portion that covers an upper surface of the adjustment portion, and a second guard portion that extends from one end of the first guard portion so as to cover a part of a side of the adjustment portion.

6. The throttle mechanism according to claim 5, wherein in the cover, a plurality of claw portions engaged with the throttle body are disposed at intervals, and any of the claw portions is disposed at a position adjacent to another end side of the first guard portion.

7. The throttle mechanism according to claim 6, wherein the second guard portion extends along a tangent to a surface of the throttle body located in an extending direction of the second guard portion.

8. The throttle mechanism according to claim 7, wherein an upper end of the claw portion adjacent to the other end side of the first guard portion and an upper end of the guard portion have a same height.

9. The throttle mechanism according to claim 4, wherein the upper end of the protruding portion and the upper end of the guard portion have a same height.
